(19) United States
(12) Patent Application Publication
(10) Pub. No.: US 2018/0141412 A1
(43) Pub. Date: May 24, 2018

(54) Suspension to compress gas cooler

(71) Applicant: Mohsen Jalilian, Bahar (IR)

(72) Inventor: Mohsen Jalilian, Bahar (IR)

(21) Appl. No.: 15/256,644

(22) Filed: Sep. 5, 2016

(51) Int. Cl. B60H 1/32; B60G 99/00; B60G 15/06

(52) U.S. Cl. CPC B60H 1/3223; B60H 2001/3295; B60G 15/06; B60G 99/002

(57) ABSTRACT

The car suspension system of current invention comprises a damper for the absorption of the forces which is exerted on a vehicle's cabin. In this model, there is no need for a compressor, belt and a power output of an engine to produce coolness, however the force of the car suspension system is utilized; that is to say, damper and compressor juxtapose in parallel to the side of the spring system which aids to damp the vibration in order to maintain stability and provides a comfortable temperature in the car cabin on hot days at no cost and drawbacks which will be discussed later.

The car suspension system of current invention comprises a damper for the absorption of the forces which is exerted on a vehicle's cabin. In this model, there is no need for a compressor, belt and a power output of an engine to produce coolness, however the force of the car suspension system is utilized; that is to say, damper and compressor juxtapose in parallel to the side of the spring system which aids to damp the vibration in order to maintain stability and provides a comfortable temperature in the car cabin on hot days at no cost and drawbacks which will be discussed later.

### BACKGROUND OF THIS INVENTION

Nowadays, for the sake of global warming, car air conditioner is not considered a luxury, but a need for air conditioning requires a good and safe driving. Today's air conditioning applies compressor for the production of coolness and circulating refrigerant. The required force to move the compressor is supplied with the net power output of the engine by a belt. This system has many disadvantages that would be perused more lately.

### BRIEF DESCRIPTION OF DRAWINGS

FIG. 1, illustrates different components of a regular engine of prior art (generator (dynamo), compressor, water pump and spindle connected to each other by a belt).

FIG. 2, displays an embodiment of the invention.

FIG. 3, displays the thermodynamic diagram (Pressure-Enthalpy) of the refrigerant gas in the cooling cycle.

FIG. 4 shows a sample of the suspension system which uses a spring (F) to swing and a dashpot (K) to damp oscillations.

FIG. 5, displays a suspension of a vehicle.

FIG. 6, displays different extension and compression of a spring.

FIG. 7, depicts a cylinder (S) and a piston (P) which moves in the cylinder.

FIG. 8, displays a working prototype of the invention.

FIG. 9, displays the inlet valve in operation.

FIG. 10, displays the outlet valve in operation.

FIG. 11, displays a built model with its components

### SUMMARY

A compression cooling system for vehicles is described comprising, an evaporator, a condenser, an expansion valve and a compressor raising a pressure of a refrigerant gas, therefore a temperature of said gas increases (hot gas); said hot gas will be cooled off (cooled gas) by passing through said condenser; wherein said cooled gas then passes through a tube of said expansion valve and enters inside said evaporator, therefore said pressure will further decreases and therefore said temperature of said cooled gas further decreases; wherein said refrigerant gas evaporates by moving through said evaporator and is guided to said compressor repeating a cooling cycle explained above.

Wherein said compressor system further comprises two front springs and two back springs; each one of said set of front and back springs having a cylinder, a piston, an inlet valve and an outlet valve; wherein when said vehicle accelerates said two front springs are stretched and therefore a front spring length increases while said two back springs are compressed and therefore a back spring length decreases; and wherein during break of said vehicle front length decreases where said back spring length increases; during turning said vehicle or passing over road holes and bumps, at least one and/or some of said two front springs and/or back springs are compressed and at least one and/or some of said two front springs and/or back springs will be stretched in order to keep said balance and suspension of said vehicle in place.

Wherein a lower end of each of said pistons is attached to one wheel and an upper end of each of said pistons where said inlet and outlet valves are located, is connected and fixed to said vehicle's body.

Wherein during each oscillation of said springs when said length of each one of said spring increases said piston moves downwards and therefore creates a partial vacuum inside said cylinder and therefore said inlet valve will open and therefore said refrigerant will move into said cylinder.

Wherein said length decreases said piston moves upwards and compresses said refrigerant into said cylinder and therefore said outlet valve is opened to lead said refrigerant inside said condenser.

### BRIEF DESCRIPTION OF THE DRAWINGS

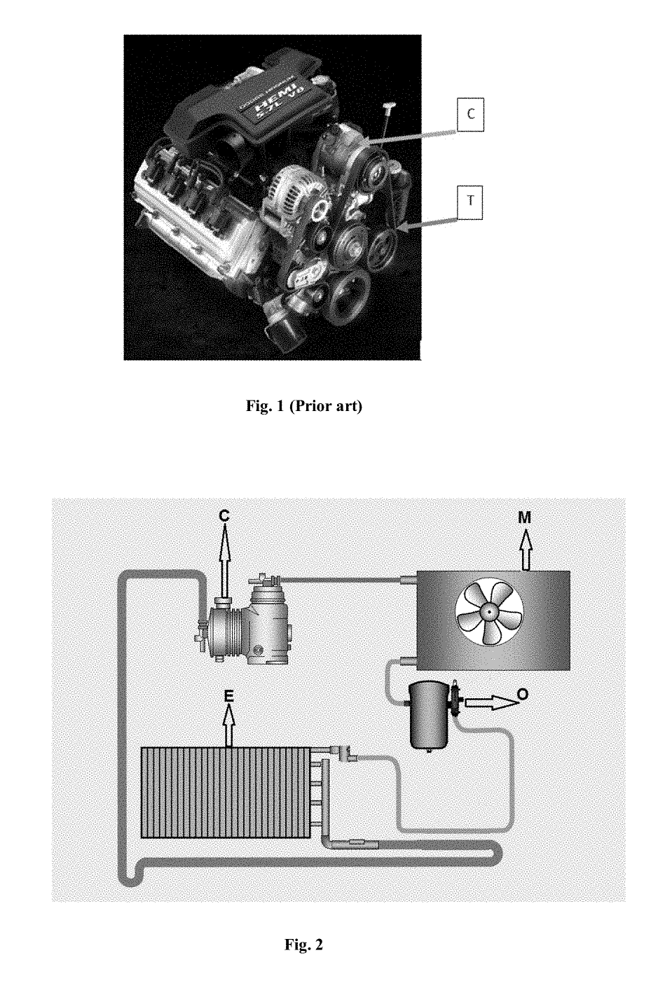

In the prior art compressors (C) receives the required power from pulley of engine (FIG. 1) by belt (T). This has a few disadvantages that some of them are named below:
1. The increase in fuel consumption
2. Suppressing the cooling system of the engine
3. Reducing the maneuverability of vehicle, especially on hills and high speeds
4. Increasing depreciation, erosion and temperature of the engine
5. Decreasing battery life and the other electric parts of the car

These disadvantages causes most drivers to use less air conditioner, but the new invention covers all the above disadvantages.

As is indicated in FIG. 2 a compression cooling system includes an evaporator (E), a condenser (M), an expansion valve (O) and the compressor (C); wherein the compressor (C) raises a pressure of a refrigerant gas. According to the law of thermodynamic, the increase in pressure of gas leads to an increase in the temperature of gas. The hot gas that is shown by red line in FIG. 2 is turned into a condenser and is cooled by fan. The refrigerant gas which has a lower temperature passing through the condenser (C), decreases in pressure as it passes through a tube of the expansion valve, and then it enters inside the evaporator. The blue line in FIG. 2 indicates that by lowering the pressure, the temperature of refrigerant gas decreases and leads to cooling of the evaporator as conscience.

Output refrigerant from the evaporator (E) moves to the compressor (C) again and this cycle circulates constantly.

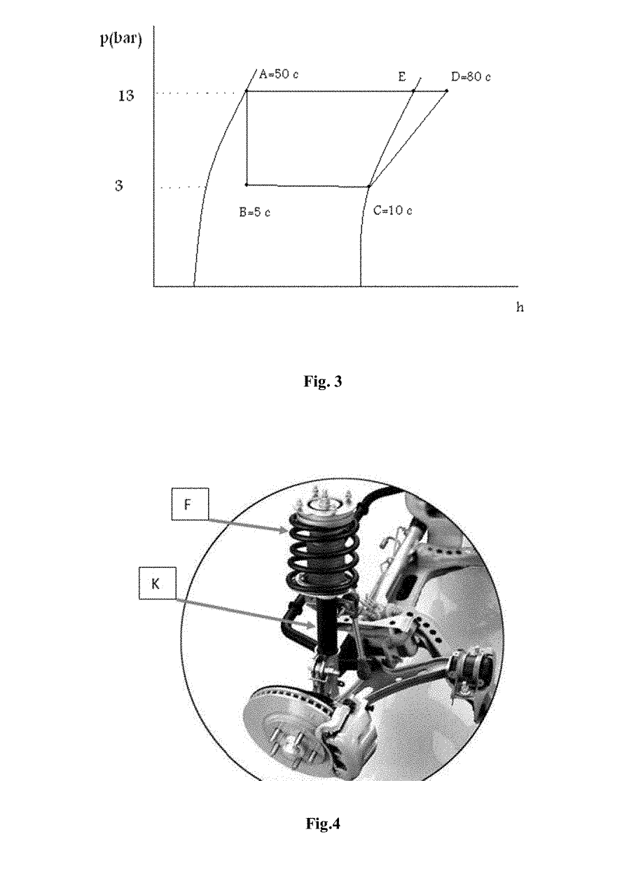

In FIG. 3, the thermodynamic diagram (Pressure-Enthalpy) illustrates the refrigerant gas in the cooling cycle that shows the minimum pressure in 3 bars by the blue lines and the maximum pressure in 13 bars by the red lines. The temperature at point A which is the outgoing gas of the condenser (C) is 50 centigrade; the temperature of B which is the incoming gas to the evaporator is 5 centigrade, and the temperature of the outgoing gas of the evaporator is 10 centigrade. Finally, the temperature of the refrigerant gas reaches to 80 centigrade in D after increasing its pressure by compressor.

The points A and D are high-pressure and the points B and C=10 are the low-pressure of the cooling cycle.

### Suspension System

In order to account for maintaining stability, endurance limit, comfort limit and avoiding accelerations which can be exerted to the occupants, a spring and a damper are applied in the car suspension system. The damper converts the oscillating forces on the car cabin to the friction that is essential to prevent the fatigue of occupants. According to calculations that were done, the damper loses power several times more than the power needed to drive the compressor.

### Scenarios are Presented by Suspension System:

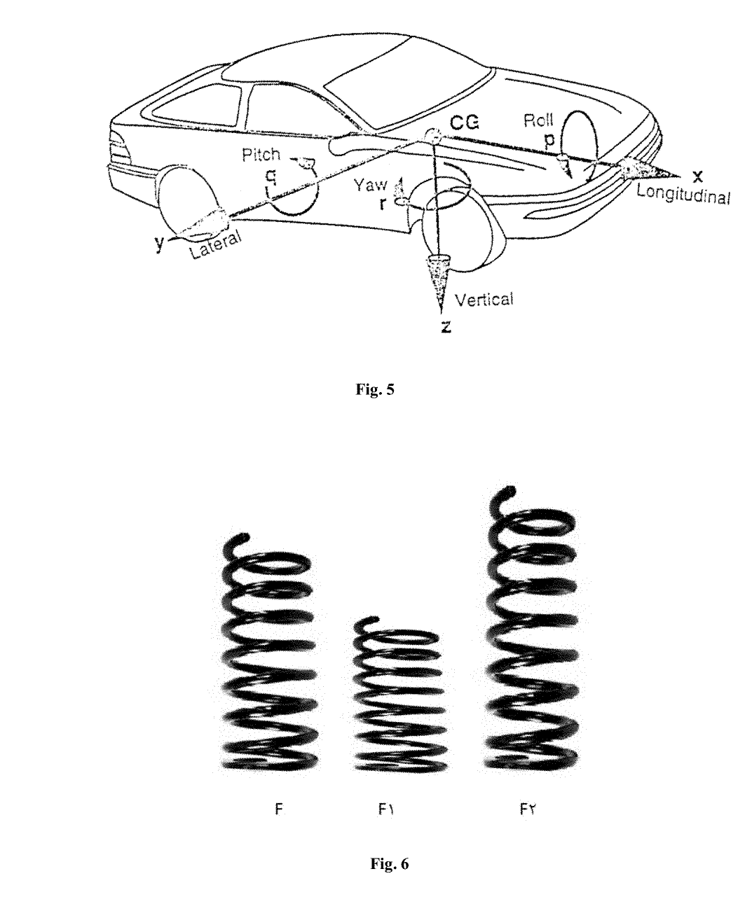

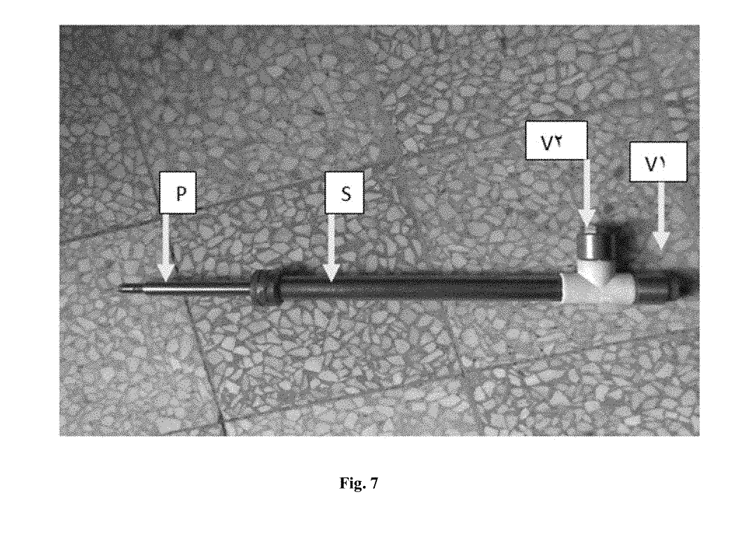

Six motions that are independent of each other occur on the vehicle's body which is due to inertia and aerodynamic loads. Three of them are linear velocity (x, y, z) and the relics are angular momentum (p, q, r) which are shown in FIG. 5. These movements which occur separately for each wheel must be absorbed by the damper for providing comfort to the occupants through the suspension system.

### Different Position of the Cabin as Follows:

By accelerating or the so-called leaping of the vehicle, the length of the back springs are decreased towards the pre-motion state (F); as a matter of fact, the springs are compacted (F1), and the length of the front springs are increased towards the previous state (F); that is, they are stretched (F2), due to the force of inertia.

In the case of braking, the above positions are became contrariwise; that is to say, the front springs are compacted (F1) and the back springs are stretched (F2).

By deviation of the vehicle to the left, the right springs are compacted (F1) and the left springs are stretched (F2); while, with the deviation of the vehicle to the right, the opposite happens.

The positions were mentioned above are true while the road is perfectly smooth and does not any declivity or curvature which is, in fact, impossible, and apart from the above, the unevenness of the road leads to more vibration of the springs.

### BEST MODE

Inlet valve (V1) is used for entering of the refrigerant into a cylinder and an outlet valve (V2) is used for exit of the refrigerant from the cylinder.

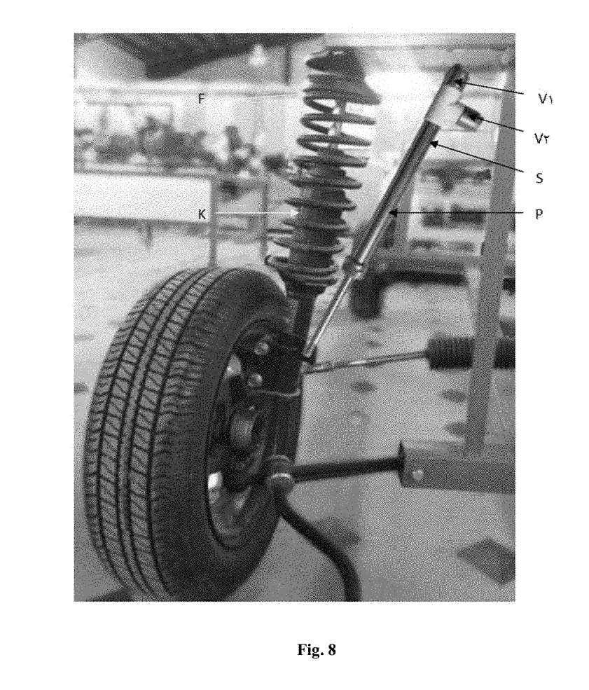

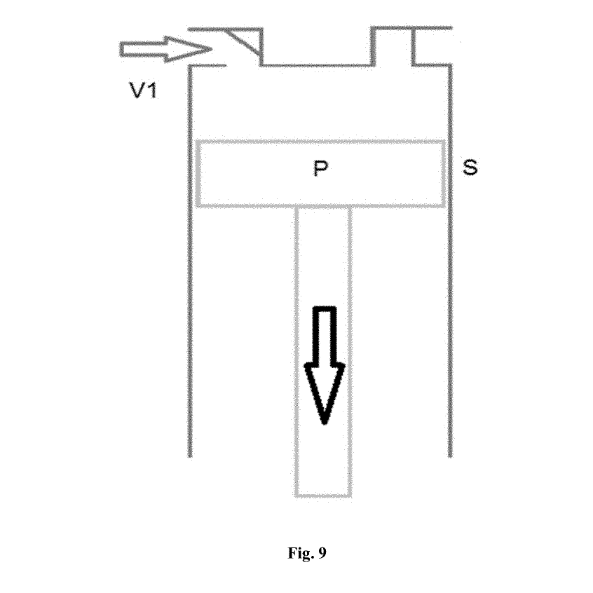

According to FIG. 8 by locating the cylinder set (S) and piston (P) and inlet check valves (V1) and outlet check valve (V2) in line with the spring and dashpot, and in parallel, the lower part of the piston (P) which is threaded is fixed to the wheel by a nut, and the upper part of the cylinder that check valves are also located on that side is fixed on the vehicle's body. By oscillating motions that occurs for each wheel relative to the body, both the suction and the compression were done.

On the basis of FIG. 9, when the distance between wheel and body is increased, the length of the spring is changed from (F) to (F2); in other words, the length of the spring is increased and consequently the piston which is attached to the wheel moves downward and causes a partial vacuum into the cylinder. This vacuum causes to open the inlet valve (V1) and leads the refrigerant into the cylinder.

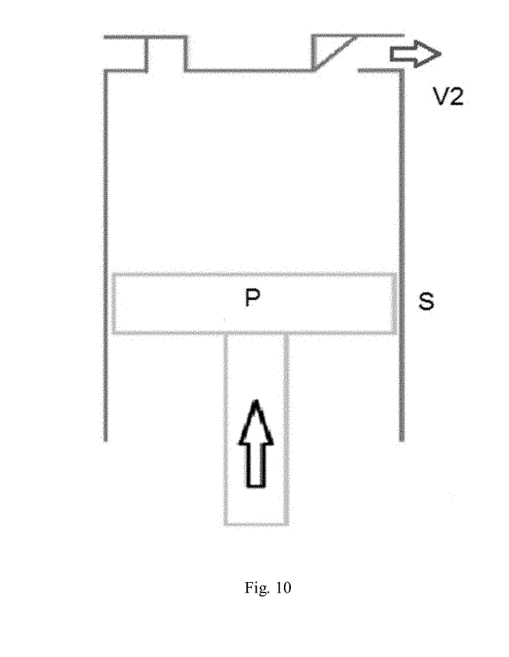

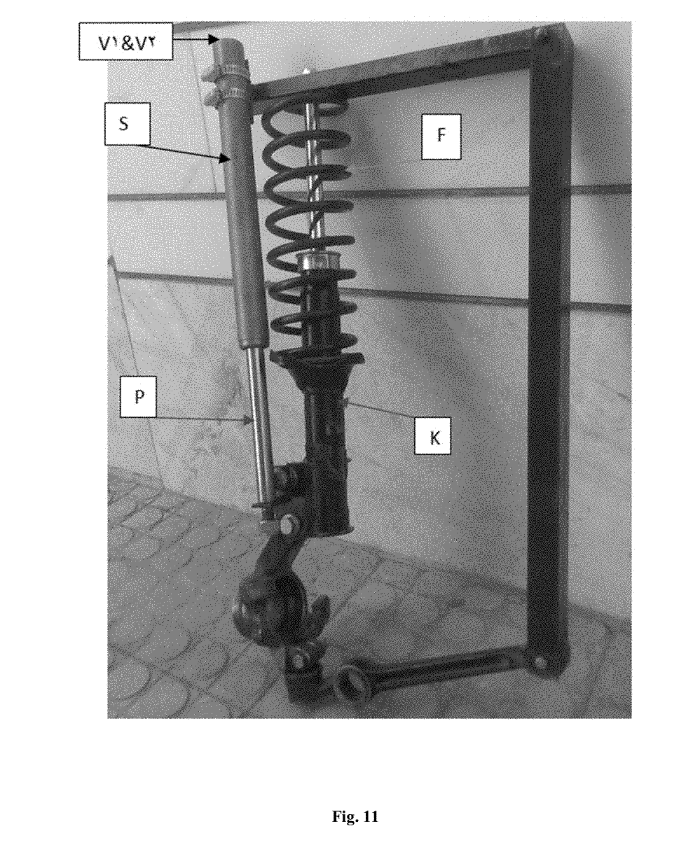

In line with FIG. 10, when the longitudinal distance between wheel and body is being decreased, the length of the spring is changed from (F) to (F1). In other words, the length of the spring is decreased and consequently the piston which is attached to the wheel moves upwards and compresses the refrigerant into the cylinder and with pressure through the check valve outlet (V2) leads to the condenser.

1- A compression cooling system for vehicles comprising, an evaporator, a condenser, an expansion valve and a compressor raising a pressure of a refrigerant gas, therefore a temperature of said gas increases (hot gas); said hot gas will be cooled off (cooled gas) by passing through said condenser; wherein said cooled gas then passes through a tube of said expansion valve and enters inside said evaporator, therefore said pressure will further decreases and therefore said temperature of said cooled gas further decreases; wherein said refrigerant gas evaporates by moving through said evaporator and is guided to said compressor repeating a cooling cycle explained above.

2- The compression cooling system of claim 1, wherein said compressor system further comprises two front springs and two back springs; each one of said set of front and back springs having a cylinder, a piston, an inlet valve and an outlet valve; wherein when said vehicle accelerates said two front springs are stretched and therefore a front spring length increases while said two back springs are compressed and therefore a back spring length decreases; and wherein during break of said vehicle front length decreases where said back spring length increases; during turning said vehicle or passing over road holes and bumps, at least one and/or some of said two front springs and/or back springs are compressed and at least one and/or some of said two front springs and/or back springs will be stretched in order to keep said balance and suspension of said vehicle in place.

3- The compression cooling system of claim 2, wherein a lower end of each of said pistons is attached to one wheel and an upper end of each of said pistons where said inlet and outlet valves are located, is connected and fixed to said vehicle's body.

4- The compression cooling system of claim 3, wherein during each oscillation of said springs when said length of each one of said spring increases said piston moves downwards and therefore creates a partial vacuum inside said cylinder and therefore said inlet valve will open and therefore said refrigerant will move into said cylinder.

5- The compression cooling system of claim 4, wherein said length decreases said piston moves upwards and compresses said refrigerant into said cylinder and therefore said outlet valve is opened to lead said refrigerant inside said condenser.
